(19) United States
(12) Patent Application Publication
(10) Pub. No.: US 2026/0235824 A1
(43) Pub. Date: Aug. 13, 2026

(54) PHOTONIC SYSTEM COMPRISING A PHOTONIC CHIP AND A MULTI-PLANE CONVERSION DEVICE

(71) Applicant: Cailabs, Rennes (FR)

(72) Inventors: Antonin Billaud, Rennes (FR); Claire Autebert, Rennes (FR); Bertrand Denolle, Rennes (FR); Siddharth Sivankutty, Rennes (FR)

(21) Appl. No.: 19/470,902

(22) PCT Filed: Apr. 10, 2024
(86) PCT No.: PCT/EP2024/059729

§ 371 Date: Sep. 30, 2025

(30) Foreign Application Priority Data
Apr. 14, 2023 (FR) FR2303763

(51) Int. Cl. G02B 6/42

(52) U.S. Cl. CPC G02B 6/4214; G02B 6/4206; G02B 6/4244; G02B 6/4245

(57) ABSTRACT

A photonic device includes a photonic chip having at least one waveguide arranged in the main plane and at least one receiving zone arranged on a surface of the photonic chip. The waveguide and the receiving zone are optically coupled to each other in order to propagate internal light radiation formed of at least one mode. The photonic device also includes a multi-plane conversion device assembled to the photonic chip and having a first optical port, optically associated with the receiving zone of the photonic chip, and a second optical port for receiving external radiation, the external light radiation being capable of propagating between the second optical port and the first optical port during a plurality of reflections and/or transmissions on microstructured zones of the multi-plane conversion device.

### CROSS-REFERENCE TO RELATED APPLICATIONS

This application is a national phase entry under 35 U.S.C. § 371 of International Patent Application PCT/EP2024/059729, filed Apr. 10, 2024, designating the United States of America and published as International Patent Publication WO 2024/213583 A1 on Oct. 17, 2024, which claims the benefit under Article 8 of the Patent Cooperation Treaty of French Patent Application Serial No. FR2303763, filed Apr. 14, 2023.

### TECHNICAL FIELD

The present disclosure relates to the field of photonic chips. It has a wide range of applications, for example, in inter- and intra-chip optical communications, especially for data centers, for producing sensors in biology or for distance measurement (LIDAR), and in telecommunications.

### BACKGROUND

Photonic integrated circuits (or photonic chips) are integrated circuits capable of generating, detecting or manipulating light radiation. These circuits, like electronic integrated circuits, can incorporate multiple functional blocks, such as laser radiation sources, switches, modulators, and power distributors, these blocks being interconnected by waveguides. The combination of these blocks allows complex light processing to be carried out in a much smaller space, at lower cost and with higher performance than with non-integrated technologies based on an arrangement of separate optical components. This is particularly true of silicon-based photonic integrated circuits, which take advantage of highly mature microelectronic techniques for manufacturing electronic integrated circuits to mass-produce optical circuits. Some optical functional blocks can comprise layers or decals of III-V semiconductors, epitaxially formed on or bonded to a predominantly silicon platform.

In all cases, the chip remains flat and generally rectangular, comprising sides on the order of a centimeter or a few centimeters in size and relatively low thickness, on the order of a millimeter or a few millimeters. The smaller faces form edge faces of the photonic chip, and the larger faces form the main surfaces of the photonic chip.

In operation, the photonic chip is borne by a PCB (printed circuit board), which also supports the other electronic and/or optical components, which might or might not be integrated, of a more complex system.

It is often necessary to inject light radiation into a waveguide of a photonic chip for processing, or to extract light radiation produced and/or processed by the chip. Light radiation injected into or extracted from the chip can propagate through free space or be guided by an optical fiber. Coupling takes place at a transmission/receiving zone of the chip.

Such an arrangement is, for example, disclosed in the document by CHO PAK ET AL: “Investigation of turbulence-tolerant free-space optical communications via multiplane light conversion,” OPTICAL ENGINEERING, SOC. OF PHOTO-OPTICAL INSTRUMENTATION ENGINEERS, BELLINGHAM, vol. 61, no. 11, Nov. 1, 2022, page 116104.

Possible coupling configurations between the light radiation and the chip can be “in-plane coupling” or “out-of-plane coupling” with respect to the plane of the chip. Reference may be made to the document by Riccardo Marchetti, Cosimo Lacava, Lee Carroll, Kamil Gradkowski, and Paolo Minzioni, “Coupling strategies for silicon photonics integrated chips [Invited],” Photon. Res. 7, 201-239 (2019). U.S. Patent Application Publication No. 2021/286140 also discloses a connector for optically connecting one or more optical fibers to a photonic chip.

Depending on the “in-plane” or “out-of-plane” nature of this coupling, the transmission/receiving zone of the photonic chip is arranged on one of its edge faces or on a main surface.

The above-mentioned document mentions that this coupling, particularly when using optical fibers, is not straightforward. This is mainly due to the great disparity in size and modal distribution between external light radiation and that propagating through a waveguide of the photonic chip. More generally, the guided modes in a photonic chip are different from the guided modes in a fiber or those of free-space radiation, which gives rise to optical losses at the coupling taking place at the transmission/receiving zone of the chip. For this reason, effective coupling between light radiation and the photonic chip is a major challenge.

### BRIEF SUMMARY

One aim of the present disclosure is to provide at least a partial solution to these problems.

With a view to achieving this aim, the subject matter of the present disclosure is a photonic device comprising:
a photonic chip extending along a main plane and comprising at least one waveguide arranged in the main plane and at least one receiving zone arranged on a surface of the photonic chip, the waveguide and the receiving zone being optically coupled to each other in order to propagate internal light radiation formed of at least one mode, the internal radiation having a first shape at the receiving zone;
a multi-plane conversion device assembled to the photonic chip and comprising a first optical port, optically associated with the receiving zone of the photonic chip, and a second optical port for receiving external radiation having a second shape, distinct from the first shape, the external light radiation being capable of propagating from the second optical port to the first optical port during a plurality of reflections and/or transmissions on microstructured zones of the multi-plane conversion device, the microstructured zones being configured to guide at least a portion of the external radiation received on the second optical port and to shape this portion into the first shape of the internal light radiation at the first optical port.

According to another aspect, the present disclosure provides a device comprising:
a photonic chip extending along a main plane and comprising at least one waveguide arranged in the main plane and at least one transmission zone arranged on a surface of the photonic chip, the waveguide and the transmission zone being optically coupled to each other in order to propagate internal light radiation formed of at least one mode, the internal radiation having a first form at the receiving zone;
a multi-plane conversion device assembled to the photonic chip and comprising a first optical port, optically associated with the transmission zone in order to receive the internal light radiation, and a second optical port for transmitting external radiation of a given shape, distinct from the first shape, the internal light radiation being capable of propagating from the first optical port to the second optical port during a plurality of reflections and/or transmissions on microstructured zones of the multi-plane conversion device, the microstructured zones being configured to guide the at least one mode of the internal light radiation received at the first optical port and to shape it into the given shape at the second optical port.

According to other advantageous non-limiting features of the present disclosure, taken alone or according to any technically feasible combination:
the multi-plane conversion device is composed of a monolithic optical part through which the external radiation propagates, the monolithic optical part having at least one face bearing the microstructured zones;
the multi-plane conversion device comprises two optical parts each having a reflective face, the reflective faces of the optical parts being arranged facing each other, and at least one of the reflective faces bearing the microstructured zones;
one of the reflective optical parts is formed by a surface of the photonic chip;
the multi-plane conversion device comprises an assembly part for assembling the two reflective optical parts together;
the assembly part is arranged as a spacer between the two reflective optical parts or as a support for the two reflective optical parts;
the transmission or receiving zone is arranged on what is referred to as a “main” face of the photonic chip, parallel to the main plane;
the transmission or receiving zone is arranged on an edge face of the photonic chip (PIC), the edge face forming a face of the photonic chip perpendicular to the main plane;
the second optical port comprises an optical fiber array (FA);
the second optical port comprises at least one multimode fiber.
the first optical port comprises a microlens array;
the first optical port comprises a light guide;
the light guide comprises a mirror, a prism or a periscope;
the photonic device comprises a support on which the photonic chip and the multi-plane conversion device are arranged;
the support comprises a reflective layer forming one of the reflective optical parts of the multi-plane conversion device;
the photonic chip comprises at least one photodetector optically associated with the waveguide (WG).

### BRIEF DESCRIPTION OF THE DRAWINGS

Other features and advantages of the present disclosure will become apparent from the following detailed description of embodiments of the present disclosure with reference to the accompanying figures, in which:

FIG. 1 shows a schematic diagram according to a first embodiment;

FIG. 2 shows a schematic diagram according to a second embodiment;

FIG. 3 shows a multi-plane conversion device MPLC that can be used in an optical system according to the present disclosure;

FIG. 4 shows one implementation of a photonic device according to the present disclosure; and

FIGS. 5, 6A-6C, and 7 illustrate possible assemblies between a multi-plane conversion device and a photonic chip in order to form a photonic device according to the present disclosure.

### DETAILED DESCRIPTION

The “shape” of light radiation designates the transverse distribution of the amplitude and the phase of the mode or the combination of the transverse amplitude and phase distributions of the modes making up this radiation.

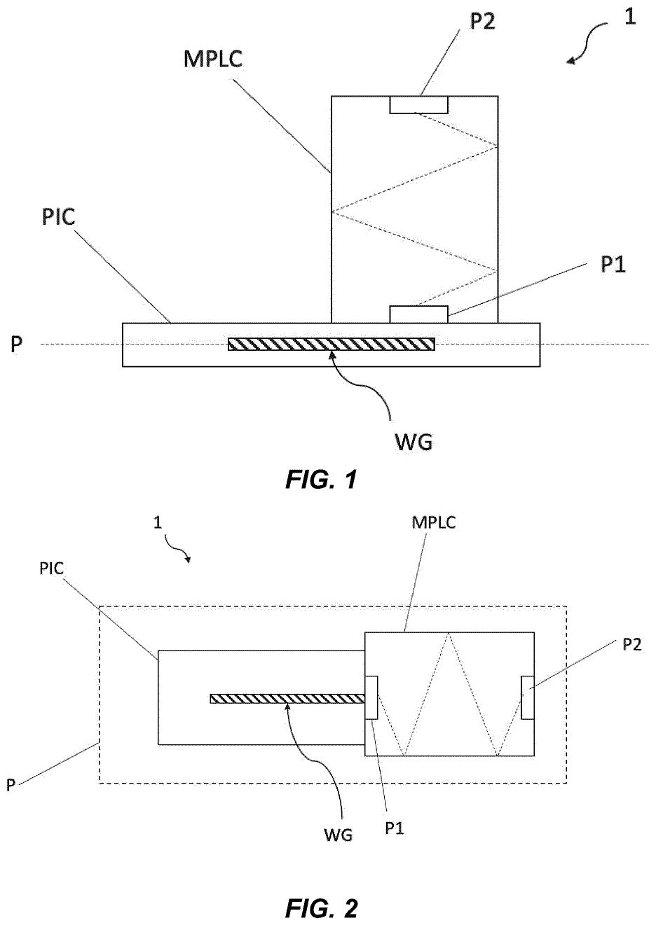

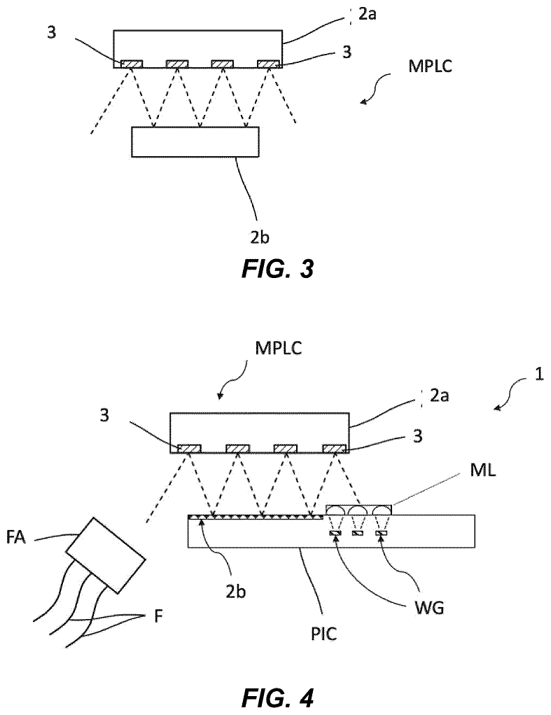

FIGS. 1 and 2 illustrate the principles implemented in a photonic system that is the subject of the present disclosure. FIG. 1 shows a side view of a first embodiment and FIG. 2 shows a top view of a second embodiment.

These schematic diagrams show a photonic device 1, here formed of a single photonic chip PIC to which a multi-plane conversion device MPLC is assembled. What is meant by “assembled” is that the conversion device and the photonic chip are secured to each other and held together without any degree of freedom.

As is well known per se, the photonic chip PIC can incorporate a variety of active elements, such as lasers, phase modulators, interferometers and photodetectors, integrated in a housing, associated with passive elements such as waveguides and optical couplers, allowing the chip PIC to be fully functional. The chip can be essentially rectangular in shape and extend along a main plane P.

In the context of the present disclosure, the photonic chip PIC contains at least one waveguide WG extending in the main plane P of the photonic chip PIC. The waveguide WG is coupled to at least one transmission zone or at least one receiving zone arranged on a surface of the photonic chip PIC. The waveguide WG and the transmission or receiving zone are optically coupled to each other in order to propagate light radiation that is internal to the chip.

A transmission zone or a receiving zone corresponds to a surface portion of the photonic chip PIC at which light radiation emerges or is injected. For simplicity of writing, such a zone will be referred to as a “transmission/receiving zone.” This surface can correspond to a main surface of the chip PIC, i.e., a surface parallel to the main plane P, or to an edge face of the chip 1, i.e., a surface perpendicular to the main plane P. The term “active surface” will be used to refer to the surface of the chip on which the transmission/receiving zone is arranged. A photonic chip PIC of the photonic device 1 that is the subject of the present disclosure can comprise a plurality of transmission/receiving zones, arranged on the active surface in any suitable arrangement. In particular, these zones can be arranged along a line or in an array on the active surface.

Light radiation internal to the photonic chip PIC is formed of at least one mode and thus propagates through the waveguide WG to/from the transmission/receiving zone. In this zone, the internal radiation has a first shape determined by the one or more modes propagating through the waveguide WG.

The radiation propagating through the waveguide WG is generally not rotationally symmetrical: for example, it may be elliptical or rectangular with rounded corners, with the long axis of the ellipse or the length of the rectangle lying in the main plane P, and the short axis of the ellipse or the width of the rectangle lying perpendicular to this main plane P. This radiation therefore has an asymmetrical shape.

Returning to the description of the schematic diagrams in FIGS. 1 and 2, the photonic system 1 also comprises a multi-plane conversion device MPLC. The multi-plane conversion device MPLC is assembled, either directly or indirectly, to the photonic chip PIC, directly in the case of the schematic diagrams shown in FIGS. 1 and 2. The multi-plane conversion device MPLC comprises a first optical port P1, optically associated with the transmission/receiving zone of the photonic chip, via the assembly of the two elements together.

In the schematic diagram shown in FIG. 1, the coupling between the multi-plane conversion device MPLC and the photonic chip PIC is achieved “from above,” out of the plane P of the chip. To this end, the transmission/receiving zone Z of the photonic chip PIC is arranged on its main surface, optically coupled to the waveguide WG via a surface coupler such as a surface grating or back reflecting mirrors.

In the schematic diagram shown in FIG. 2 (top view), the coupling between the multi-plane conversion device MPLC and the photonic chip PIC is achieved “from the edge,” in the plane of the chip. In this configuration, the transmission/receiving zone Z of the photonic chip PIC is arranged on one of its edge faces, via an edge coupler.

The multi-plane conversion device MPLC also comprises a second optical port P2 for receiving/transmitting light radiation, referred to as “external” radiation, external to the photonic device 1. Light radiation can propagate between the first optical port P1 and the second optical port P2 during a plurality of reflections and/or transmissions on microstructured zones of the multi-plane conversion device, as will be explained in greater detail in a later section of this disclosure.

The propagation of this light radiation goes from the first optical port P1 to the second port P2 when the source of this radiation is coupled to the first optical port P1, on the side of the photonic chip PIC, configured in this case “in transmission mode.” Conversely, the propagation of this light radiation goes from the second optical port P2 to the first optical port P1 when the source is arranged on the side of the second optical port P2, the photonic chip PIC being configured in this case “in receiving mode.”

The term “optical port” refers to any part or passageway used to add/remove light radiation to/from of the multi-plane conversion device MPLC.

In all cases, the external light radiation, which emerges from the photonic system 1 from the second optical port P2, or is injected into the photonic system 1 via this second optical port P2, has a second shape, which is distinct from the first shape of the internal radiation propagating through the photonic chip PIC. The shape of the external radiation can be dictated by a waveguide, for example, an optical fiber or a bundle of optical fibers connecting the photonic system 1 to a source or receiver external to this system. It can also be dictated by this source or receiver directly, when the propagation of the external light radiation between the photonic system 1 and this source or receiver takes place in free space.

By way of example, external radiation carried by a single-mode optical fiber, the end of which would be placed at the second optical port P2, produces, at this second port, light radiation with a Gaussian shape, thus exhibiting rotational symmetry, which does not correspond to the generally elliptical shape of the internal radiation propagating through the waveguide WG of the photonic chip PIC.

The shape of the light beam at the second optical port is not necessarily perfectly determined. Thus, propagation to this second optical port from a remote external source can cause significant distortion of the radiation, affecting its shape and making it variable over time. This is also the case when propagation is partly via a multimode waveguide, since not all modes are loaded with the same intensity over time, which can make the shape of the radiation transmitted by this fiber variable over time. The shape of this radiation can also be affected by variations in temperature or mechanical stresses that a fiber can undergo.

As stated in the introductory part of this application, the shape of the external radiation is generally not matched to the first shape of the light radiation determined by the one or more modes propagating through the photonic chip PIC. The coupling of the light radiation to the chip PIC, due to this difference in shape, is subject to significant losses.

To counter this, the multi-plane conversion device MPLC is configured to perform a shape conversion on the radiation propagating between the first and second optical ports. It should be noted that this shape conversion is particularly complex: it involves transforming the external radiation, or part thereof, into the asymmetrical first shape of the radiation internal to the photonic chip. As such, it is not just a question of a mere change in size, or more generally, a straightforward homothetic transformation of radiation. This is all the more true as the shape of the external radiation can vary over time.

A photonic device in accordance with the present disclosure is devoid of any optical elements between the first optical port of the multi-plane conversion device and the receiving zone Z of the photonic chip PIC, which could impose a particular shape on the radiation propagating there. In particular, the device is devoid of any optical fibers for linking the first optical port of the multi-plane conversion device and the receiving zone Z of the photonic chip PIC.

### Photonic Chip Suitable for Operation in Transmission Mode

When the photonic chip PIC is suitable for operation in transmission mode, for example, when it comprises a light source coupled by the waveguide WG to a transmission zone, the multi-plane conversion device MPLC can be configured to transform the optical mode produced at this transmission zone, at the first optical port P1, into external radiation of chosen shape. In other words, the multi-plane conversion device MPLC is configured to guide the internal light radiation received at the first optical port P1 and shape it to the chosen (i.e., determined) shape at the second optical port P2. In particular, this shape can be chosen so as to be injected efficiently into an optical fiber arranged at its second optical port P2, for example, by producing Gaussian-shaped radiation at this second optical port.

If the internal radiation within a waveguide WG of the photonic chip is composed of a plurality of modes, it is possible to configure the multi-plane conversion device MPLC as a spatial demultiplexer, whereby at least some of the modes of this internal radiation can be isolated from each other and transformed so as, for example, to be injected into a dedicated optical fiber at the second optical port P2.

When the photonic chip PIC comprises a light source or a plurality of light sources of which the radiation is distributed in a plurality of disjunct waveguides, the multi-plane conversion device MPLC can be configured to transform the optical mode making up the internal radiation propagating through each waveguide WG into radiation of which the shape, at the second optical port P2, allows it to be efficiently injected into a dedicated optical fiber. Alternatively, the optical modes propagated collectively by the waveguides to the transmission zones of the photonic chip PIC can be processed by the multi-plane conversion device MPLC, configured as a spatial multiplexer, in order to be respectively shaped to the modes of a multimode optical fiber.

When the shape of the radiation produced at the second optical port P2 is not constrained by a waveguide, optical fiber or bundle of optical fibers, for example, and the external radiation is intended to propagate through free space, it may nevertheless be desirable for this external radiation to be composed of modes selected from a predetermined family of modes, to facilitate the processing thereof downstream of its propagation. Examples may include a Hermite-Gauss mode family (with circular or elliptical support), or generalized Hermite-Gauss, Laguerre-Gauss, Slepian, LP or OAM modes, or any spatial unitary transformation of these mode families.

The multi-plane conversion device MPLC can implement other types of processing on the radiation produced by the photonic chip PIC than those aimed at transforming its shape. This device can, for example, produce a coherent or incoherent combination of the radiation produced.

### Photonic Chip Suitable for Operation in Receiving Mode

The photonic chip PIC may also be able to operate in receiving mode in order to process the internal radiation propagating through the waveguide WG. This processing can be of any kind, for example, detecting the intensity of this radiation via a photodetector, or combining internal radiation propagating through a plurality of waveguides WG of the chip. Other applications may include coherent detection via a local oscillator, phase change demodulation by interfering two consecutive symbols, and eye diagram enhancement.

In this case, the multi-plane conversion device MPLC can be configured to guide at least a portion of the external radiation received at the second optical port P2 and shape this portion to the one or more modes of the internal light radiation at the first optical port P1.

When this external light radiation is guided to the second optical port P2 of the multi-plane conversion device MPLC by an optical fiber, this device can be configured to transform the shape, which is typically Gaussian, of the light radiation produced by this optical fiber into a shape corresponding to the optical mode associated with the waveguide WG of the photonic chip PIC.

When the external radiation is guided by multiple fibers or by a multimode optical fiber, the multi-plane conversion device MPLC can be configured to decompose this external radiation according to at least some of the modes guided by the one or more fibers and to inject it into a plurality of waveguides WG of the photonic chip, via a plurality of receiving zones to which these waveguides are respectively coupled.

Similarly, when the external radiation propagates through free space to the second optical port P2, the multi-plane conversion device MPLC can be configured to spatially decompose at least a portion of this radiation into a plurality of modes, and to guide the propagation of these modes to the first optical port P1 and shape them to the optical modes of one or a plurality of waveguides WG of the photonic chip PIC.

The multi-plane conversion device MPLC can implement other types of processing on the radiation produced by the photonic chip PIC than those aimed at transforming its shape. This device can, for example, produce a coherent or incoherent combination of the radiation produced.

### Configuration of a Multi-Plane Conversion Device

In very general terms, a multi-plane conversion device performs a unitary transformation of the shape of incident light radiation. This transformation can be precisely described in modal form, i.e., by defining a relationship between modes of a first family of modes defined in a first transverse plane (e.g., at the first optical port P1) and modes of a second family of modes defined in a second transverse plane (e.g., at the second optical port P2). Mode families are generally formed from orthonormal bases, and allow any light radiation to be optimally decomposed at each of the optical ports.

In the context of the present disclosure, for example, the modes of the first family can be selected so that they correspond to the optical modes of a waveguide or of a plurality of waveguide WGs of the photonic chip PIC. The modes of the second family can be those that best decompose the external radiation, for example, Gaussian modes spatially associated with the optical fibers of a fiber bundle coupled to the second optical port, or modes spatially arranged in an array in order to capture and decompose external radiation propagating through free space. Other types of decomposition are possible, for example, from a Hermite-Gauss mode family (with circular or elliptical support), or generalized Hermite-Gauss, Laguerre-Gauss, Slepian, LP or OAM modes, or any spatial unitary transformation of these mode families.

For the sake of completeness, it is recalled that in such a multi-plane conversion device, the light radiation that propagates therethrough undergoes a series of reflections and/or transmissions, each reflection and/or transmission being followed by free-space propagation of the radiation. At least some of the optical parts on which the reflections and/or transmissions take place, and which guide the propagation of the light radiation in the multi-plane conversion device, have microstructured regions on which the reflections and/or transmissions take place and which modify the shape of this light radiation in order to implement a selected unitary transformation of the spatial modes.

The term “microstructured zone” means that the surface of the optical part has on each of these zones a raised portion, which can, for example, be broken down in the form of “pixels” of which the dimensions may be between a few microns and a few hundred microns. These may be metasurfaces. The raised portion or each pixel of this raised portion has a variable elevation with respect to a mean plane defining the surface in question, of at most a few microns or at most a few hundreds of microns. Regardless of the nature of the microstructuring of the zones, an optical part having such zones forms a phase mask introducing a local phase shift within the transverse section of the beam that is reflected there or transmitted there.

Thus, the light radiation propagating between the first and second optical ports P1, P2 within the multi-plane conversion device MPLC undergoes a series of local phase shifts separated by propagations. The series of these elementary transformations (for example, at least four consecutive transformations such as 8, 9, 10, 12, 13, 14, or even at least 20 transformations, for example) establishes an overall transformation of the spatial profile of the incident radiation (its shape, according to the definition of this term). It is thus possible to configure the microstructured reflection or transmission zones to break down and transform incident radiation of one predetermined shape into emergent light radiation of another predetermined shape, i.e., radiation of which the spatial arrangement in an output plane of the multi-plane conversion device can be very precisely controlled.

The documents “Programmable unitary spatial mode manipulation,” Morizur et Al, J. Opt. Soc. Am. A/Vol. 27, No. 11/November 2010; N. Fontaine et Al., (ECOC, 2017), “Design of High Order Mode-Multiplexers using Multiplane Light Conversion”; U.S. Pat. No. 9,250,454 and US2017010463 contain the theoretical foundations and examples of practical implementation of a device MPLC. In particular, these documents describe digital design methods that can be used to determine the phase profile of the phase masks of the device (i.e., the microstructured zones) according to the established unitary modal transformation. The phase masks can then be produced from the established digital model, for example, by etching or photolithography of the optical part bearing them, in order to microstructure it. The microstructuring that is applied to the optical parts configures the chosen architecture so that it implements the desired transformation.

A multi-plane conversion device can be composed of a plurality of optical parts for guiding the transmission/reflection sequence. Reference may be made, in particular, to document EP3785064, which illustrates this type of implementation. Alternatively, the device can be composed of a single “monolithic” optical part, inside which the light radiation is reflected a plurality of times on surfaces inside the part (see document EP3732525). At least some of these internal surfaces can bear the microstructured zones.

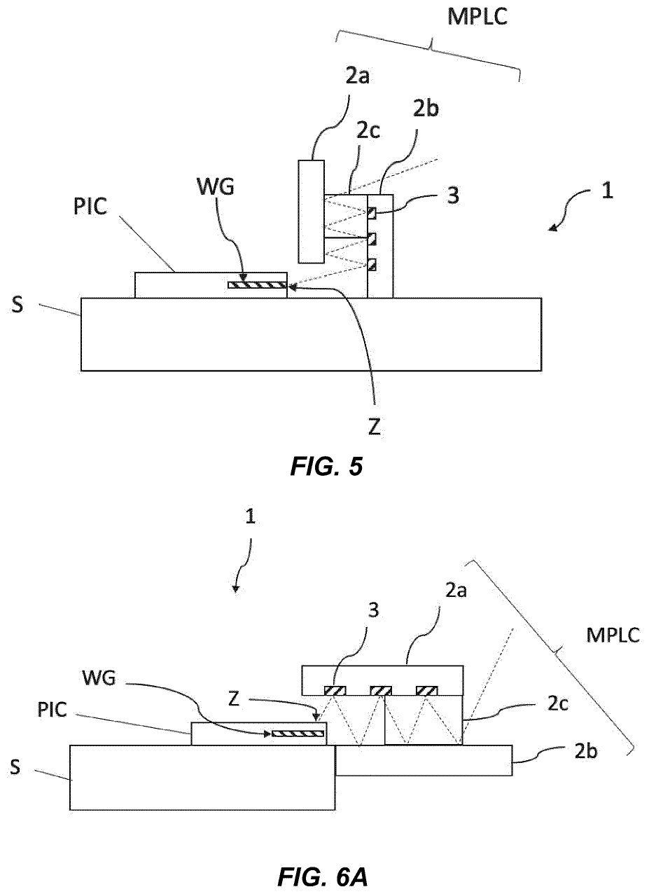

With reference to FIG. 3, and by way of example, a multi-plane conversion device MPLC has been shown, which can be used in the optical device 1 that is the subject of the present disclosure. In the architecture shown, the MPLC consists of two reflective optical parts 2a, 2b arranged facing each other. Microstructured phase masks 3 are borne by one of these parts. This forms a multipass cavity in which the incident radiation is reflected and phase-shifted a plurality of times at each microstructured mask 3 in order to transform the incident radiation. Here, the phase masks are all borne by a phase plate 2a featuring microstructured zones forming the masks, the second optical part 2b being a simple mirror. Of course, masks can be borne by each of the optical parts 2a, 2b.

The shape transformation performed by the multi-plane conversion device MPLC of a photonic device 1 of the present disclosure ensures a quality coupling, with reduced optical losses, between the photonic chip 1 and its external environment.

For simplicity of presentation, FIGS. 1 to 3 illustrate a photonic system in which a single external light beam was coupled to a single waveguide WG of the chip PIC. As already stated, it is of course possible to implement more complex couplings. In this way, the chip can be equipped with a plurality of transmission/receiving zones, some of which can operate in transmission mode and others in receiving mode. In such a case, the multi-plane conversion device MPLC is configured to respectively link portions of external light radiation to the transmission/receiving zones.

The multi-plane photonic device MPLC can contain parts other than those shown in FIG. 3. These may include optical components such as a mirror, prism, microlens or any other component for guiding external light radiation into the multi-plane device MPLC, or for guiding light radiation between the first optical port P1 and the transmission/receiving zone Z. There may also be a support, or a plurality of supports assembled together, for positioning the reflective optical parts and optical components of the device MPLC relative to each other, or even for assembling the multi-plane conversion device MPLC to the photonic chip PIC.

Similarly, the photonic device 1 can comprise elements other than the photonic chip PIC and the multi-plane conversion device MPLC. It can thus comprise a support, for example, a printed circuit board or interposer, on which the photonic chip PIC rests and which comprises electrical connection tracks or vias to which the chip is electrically connected. This support can bear other chips, whether electronic or photonic, electrically or optically connected to each other. This support can be used to assemble the multi-plane conversion device MPLC, so that the first optical port P1 of this device is well optically coupled to the transmission/receiving zone of the chip. The chip PIC can be equipped on its active surface, bearing the transmission/receiving zone or the plurality of transmission/receiving zones, with optical matching parts such as a prism and/or collimating and/or shaping lenses that constitute or form part of the first optical port P1 of the device MPLC.

### Implementations

In one advantageous configuration, the photonic chip PIC and the multi-plane conversion device MPLC are integrated with each other. For example, a main surface of the photonic chip PIC may form one of the reflective optical parts 2a, 2b defining the multipass cavity of the multi-plane conversion device MPLC. For this purpose, this main surface can be provided, by deposition, with a thin layer of a reflective material. It is also possible to microstructure this surface so that it bears the microstructured masks 3 for transforming the incident radiation.

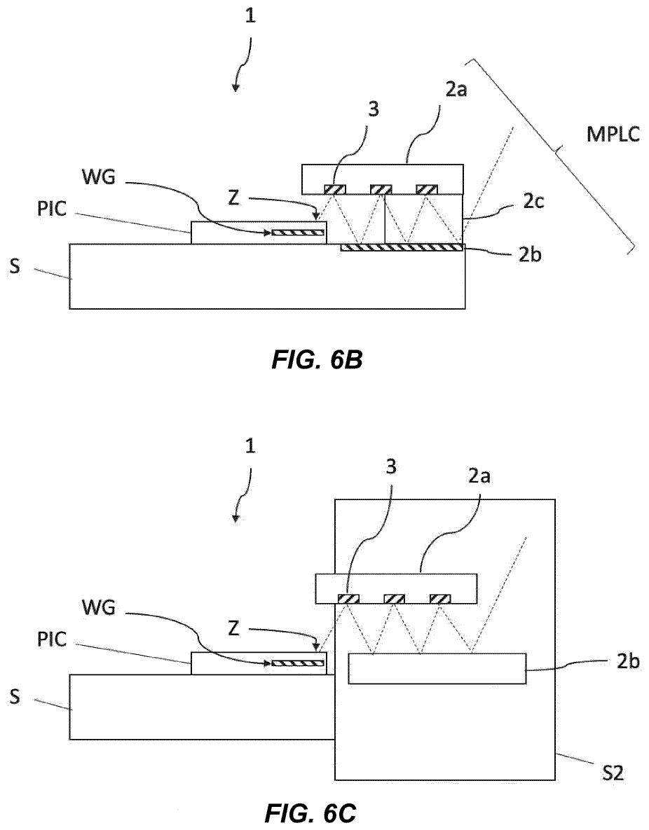

By way of illustration, FIG. 4 shows an optical device 1 for linking a photonic chip PIC and a bundle of optical fibers F, for example, single-mode fibers. These fibers collectively propagate light radiation made up of modes that are spatially separated from each other, and the shape of which is generally Gaussian.

In the example shown in this FIG. 4, the multi-plane conversion device MPLC is formed of a first reflective optical part 2a bearing the microstructured masks 3. It is positioned facing a main face of the photonic chip PIC. This main face is provided with a reflective layer, which constitutes the second reflective optical part 2b of the multi-plane conversion device MPLC, and which, in combination with the first optical part 2a, defines the multipass cavity of this device.

The second optical port of the device MPLC is formed of an optical fiber array FA. It is recalled that the term “fiber array” refers to the mechanical part placed at the end of a bundle of optical fibers in order to hold them together in a very precise arrangement, for the purpose of coupling these fibers. The end of the fibers can be arranged along a line or in a plane, and both modes of implementation are compatible with a photonic device 1 according to the present disclosure.

Returning to the description of FIG. 4, the second optical port of the device MPLC consists of the optical fiber array FA, which holds and precisely positions the ends of a bundle of single-mode optical fibers F. The light radiation produced at this second optical port can be broken down into a family of Gaussian modes, more generally referred to as the “second mode family,” each mode in the family being spatially aligned with the end of a fiber held in the fiber bundle FA.

The first optical port of the device MPLC shown in FIG. 4 is formed of a microlens array ML. The microlens array ML is arranged on the main face of the photonic chip PIC (the active face of this chip) at the locations of the transmission/receiving zones arranged on this surface. More precisely, each microlens of the microlens array ML is arranged facing one of these zones, to ensure optical coupling between a microlens and a waveguide WG, a cross section of which is shown in FIG. 4.

The light radiation produced at the first optical port P1 can be decomposed using a first family of modes, which can form a decomposition basis. This first family can be made up of modes that overlap, respectively and spatially, with the microlenses of the microlens array ML, and thus with a transmission/receiving zone of the photonic chip PIC. Each of these modes can have a shape corresponding to the mode (or to a mode) of the internal radiation propagating through a waveguide of the photonic chip.

As described in detail in the above-mentioned documents on the design of a multi-plane conversion device MPLC, the microstructured zones 3 borne by the optical part 2a are configured to perform a modal conversion in order to respectively match up the modes of the first and second mode families. The energies present in the modes of one of these families are transported and respectively shaped to the modes of the other mode family, during consecutive reflections of the radiation on the microstructured masks 3 as it propagates through the cavity of the multi-plane conversion device MPLC.

Of course, the various elements disclosed in the example illustrated in FIG. 4 are in no way limiting. In particular, it is possible to choose modes other than those illustrated.

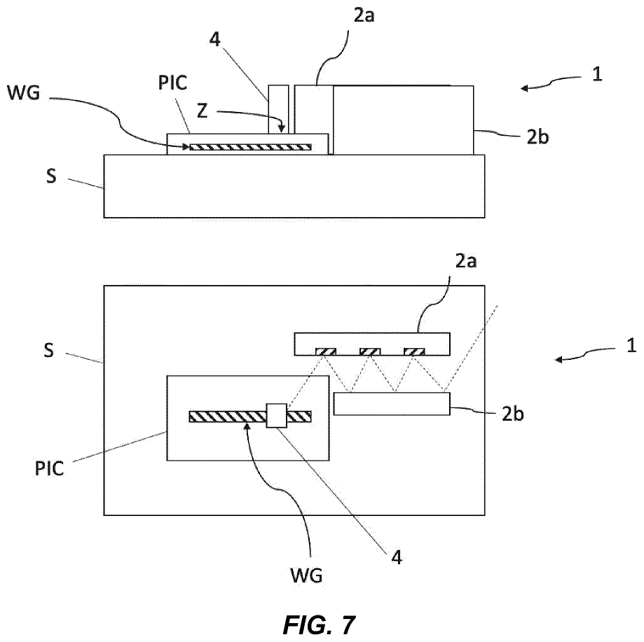

The assembly of the multi-plane conversion device MPLC to the photonic chip PIC may involve additional parts, such as alignment cubes, to control the position and orientation of the elements to be assembled relative to each other. The rest of this description, with reference to FIGS. 5 to 7, presents possible assembly examples. For the sake of legibility of the figures, any components forming the first and second optical ports of the multi-plane device MPLC have been omitted, but it is understood that the photonic devices shown in these figures may comprise such components, in accordance with the general description given in the preceding sections of this disclosure.

FIG. 5 thus shows a first example of assembly between a multi-plane conversion device MPLC and a photonic chip PIC in order to form a photonic device 1. This device 1 comprises a support S with a main face on which the photonic chip PIC is mounted. This may be a printed circuit board on which other electronic and/or optical components (not shown) are also mounted, optically/electrically connected together to form a functional system.

An exposed edge face of the photonic chip PIC bears the transmission/receiving zone Z or a plurality of such zones. A waveguide WG on the chip PIC is optically linked to this zone Z, via an edge coupler integrated into the chip. The multi-plane conversion device MPLC is formed of two reflective optical parts 2a, 2b, facing each other, one of which bears the microstructured masks 3. As already stated, these masks could be borne by either or both of these optical parts 2a, 2b. The two optical parts 2a, 2b are held together, in the example shown, by an assembly part 2c arranged, for example, as a spacer between the two reflective optical parts 2a, 2b or forming a support for assembling the edge faces of the two reflective optical parts 2a, 2b. In the example shown in FIG. 5, one of the optical parts 2a, 2b is assembled by one of its edge faces (i.e., a face of this optical part perpendicular to the reflective face defining one side of the multipass cavity) to the main face of the support S (the face to which the photonic chip PIC is also assembled). The multi-plane conversion device MPLC is positioned on the support S, relative to the photonic chip PIC, in an arrangement that ensures optical coupling between the photonic chip PIC and the multi-plane conversion device MPLC.

FIG. 6A shows a photonic device 1 in which the coupling between the multi-plane conversion device MPLC and the photonic chip PIC is achieved this time via surface coupling of the photonic chip PIC associated with the waveguide WG. The transmission/receiving zone Z of the chip PIC is arranged on the exposed main face of this chip, its other main face resting on the support S. The multi-plane conversion device MPLC is, as in the example of FIG. 5, composed of two reflective optical parts 2a, 2b, assembled to each other by means of the assembly part 2c, the spacer or support for these parts 2a, 2b. In FIG. 6A, and to allow optical coupling between the two elements, one of the reflective optical parts 2a, 2b is joined by its edge face to the edge face of the support S.

FIG. 6B shows one variant of the example of FIG. 6A. In this variant, the reflective optical part 2b of FIG. 6A is implemented by a reflective layer formed directly on the substrate S.

FIG. 6C shows yet another variant of FIG. 6A. In this variant, the assembly part for the two optical parts takes the form of a second support S2. This second support S2 is assembled to the support S on which the photonic chip PIC is mounted, to allow optical coupling of the multi-plane conversion device to this chip PIC.

FIG. 7 shows a side view (upper part of the figure) and a top view (lower part of the figure) of a photonic device 1 in which the coupling between the multi-plane conversion device MPLC and the photonic chip PIC uses a light guide 4 for the light radiation. This light guide 4 can be formed by at least one mirror, prism, periscope or a combination of these elements. It can be used to change the direction of propagation of the radiation to allow coupling to the chip PIC. This light guide can form a component of the first port P1 of the multi-plane conversion device MPLC.

The photonic device shown in the example has a support S on which the photonic chip 1 and the two reflective optical parts 2a, 2b forming the multi-plane conversion device rest. Radiation propagates in a first direction through the multi-plane conversion device, in this case parallel to the support S. This direction intercepts the light guide 4. This is located in line with the transmission/receiving zone Z of the photonic chip PIC. The light guide orients the radiation in a second direction of propagation more conducive to its coupling to the chip, in this case perpendicular to the plane of the chip PIC.

A device in accordance with the present disclosure can of course be considered using a light guide 4 coupling the multi-plane conversion device MPLC by the edge face to the photonic chip PIC.

Naturally, the present disclosure is not limited to the embodiments described, and it is possible to add alternative embodiments without departing from the scope of the invention as defined by the claims.

1. A photonic device, comprising:
a photonic chip extending along a main plane and comprising at least one waveguide arranged in the main plane and at least one receiving zone arranged on a surface of the photonic chip, the waveguide and the receiving zone being optically coupled to each other in order to propagate internal light radiation formed of at least one mode, the internal radiation having a first shape at the receiving zone; and
a multi-plane conversion device assembled to the photonic chip and comprising a first optical port, optically associated with the receiving zone of the photonic chip, and a second optical port for receiving external radiation having a second shape, distinct from the first shape, the external light radiation being capable of propagating from the second optical port to the first optical port during a plurality of reflections and/or transmissions on microstructured zones of the multi-plane conversion device, the microstructured zones being configured to guide at least a portion of the external radiation received on the second optical port and to shape the at least a portion of the external radiation into the first shape of the internal light radiation at the first optical port.

2. A photonic device, comprising:
a photonic chip extending along a main plane and comprising at least one waveguide arranged in the main plane and at least one transmission zone arranged on a surface of the photonic chip, the waveguide and the transmission zone being optically coupled to each other in order to propagate internal light radiation formed of at least one mode, the internal radiation having a first form at the receiving zone; and
a multi-plane conversion device assembled to the photonic chip and comprising a first optical port, optically associated with the transmission zone in order to receive the internal light radiation, and a second optical port for transmitting external radiation of a given shape, distinct from the first shape, the internal light radiation being capable of propagating from the first optical port to the second optical port during a plurality of reflections and/or transmissions on microstructured zones of the multi-plane conversion device, the microstructured zones being configured to guide the at least one mode of the internal light radiation received at the first optical port and to shape the at least one mode of the internal light into the given shape at the second optical port.

3. The photonic device of claim 1, wherein the multi-plane conversion device is composed of a monolithic optical part through which the external radiation propagates, the monolithic optical part having at least one face bearing the microstructured zones.

4. The photonic device of claim 1, wherein the multi-plane conversion device comprises two optical parts each having a reflective face, the reflective faces of the optical parts being arranged facing each other, and at least one of the reflective faces bearing the microstructured zones.

5. The photonic device of claim 4, wherein one of the reflective optical parts is formed by a surface of the photonic chip.

6. The photonic device of claim 4, wherein the multi-plane conversion device comprises an assembly part for assembling the two reflective optical parts together.

7. The photonic device of claim 6, wherein the assembly part is arranged as a spacer between the two reflective optical parts or as a support for the two reflective optical parts.

8. The photonic device of claim 1, wherein the transmission or receiving zone is arranged on a main face of the photonic chip, parallel to the main plane.

9. The photonic device of claim 1, wherein the transmission or receiving zone is arranged on an edge face of the photonic chip, the edge face forming a face of the photonic chip perpendicular to the main plane.

10. The photonic device of claim 1, wherein the second optical port comprises an optical fiber array.

11. The photonic device of claim 1, wherein the second optical port comprises at least one multimode fiber.

12. The photonic device of claim 1, wherein the first optical port comprises a microlens array.

13. The photonic device of claim 1, wherein the first optical port comprises a light guide.

14. The photonic device of claim 1, wherein the light guide comprises a mirror, a prism or a periscope.

15. The photonic device of claim 1, further comprising a support on which the photonic chip and the multi-plane conversion device are arranged.

16. The photonic device of claim 15, wherein the multi-plane conversion device comprises two optical parts each having a reflective face, the reflective faces of the optical parts being arranged facing each other, and at least one of the reflective faces bearing the microstructured zones, and wherein the support comprises a reflective layer forming one of the reflective optical parts of the multi-plane conversion device.

17. The photonic device of claim 1, wherein the photonic chip comprises at least one photodetector optically associated with the waveguide.

18. The photonic device of claim 2, wherein the multi-plane conversion device is composed of a monolithic optical part through which the external radiation propagates, the monolithic optical part having at least one face bearing the microstructured zones.

19. The photonic device of claim 2, wherein the multi-plane conversion device comprises two optical parts each having a reflective face, the reflective faces of the optical parts being arranged facing each other, and at least one of the reflective faces bearing the microstructured zones.

20. The photonic device of claim 19, wherein one of the reflective optical parts is formed by a surface of the photonic chip.
